(19) United States
(12) Patent Application Publication
(10) Pub. No.: US 2011/0294556 A1
(43) Pub. Date: Dec. 1, 2011

(54) MOBILE PHONE CASE WITH CARD SLOT

(76) Inventors: Jeff Carlberg, Scottsdale, AZ (US); Greg Wolf, Chandler, AZ (US)

(21) Appl. No.: 12/787,126

(22) Filed: May 25, 2010

(51) Int. Cl. H04W 99/00

(52) U.S. Cl. 455/575.8

(57) ABSTRACT

A mobile phone case includes a body defining a cavity with dimensions substantially equal to a mobile phone. The cavity includes a bottom wall forming a rear wall of the body and side walls that enclose a mobile phone on the back and four edges. The body is formed of a flexible, resilient material. The rear wall of the body includes two parallel adjacent surfaces positioned to define a card pocket on the rear wall of the body. The card pocket is formed to receive therein one or more cards side-ways and parallel to the rear wall with a portion of the one or more cards exposed.

### FIELD OF THE INVENTION

This invention relates in general to cases for carrying and protecting mobile phones and more specifically to a case that includes a card slot for carrying cards and the like.

### BACKGROUND OF THE INVENTION

At the present time, mobile phones are very popular and are also very small and subject to being damaged in various ways including, for example, dropping, inadvertently striking them against solid objects, etc. To prevent or reduce damage in any of these events, cases have been designed or proposed that substantially surround portions or the entire mobile phone. In most situations the cases are either inconvenient or insufficiently protective.

For example, cases are provided that simply hold the mobile phone, similar to handbags or tote bags, and the phone must be removed to be used. This is very inconvenient. Such cases are generally constructed of cloth or leather and do not protect the phone during actual use. In fact some damage can be done to the phone while trying to extricate it from the bag so that it can be used. Also, the bags are generally relatively light material to facilitate carrying and the phones can be damaged through the bag by dropping, swinging the bag against an object, etc.

In another type of case the phone is partially surrounded by a stiff material, such as plastic or metal, which protects surfaces and corners while allowing use of the phone without removing it from the case. At least one problem with such cases is that they do not actually absorb a blow, such as when the phone is dropped, but can be dented and can transfer the dent directly to the phone.

Further, because the phone case and phone are normally kept in a convenient location, the case may be constructed to perform other minimal tasks, such as holding credit/debit cards, money (bills), etc. This requires either a closable pocket in the case or some other means for securely holding the extra items while allowing the easy removal for use. In many such cases, because of the need to hold the cards securely, the cards are hard to remove for use.

It would be highly advantageous, therefore, to remedy the foregoing and other deficiencies inherent in the prior art.

Accordingly, it is an object of the present invention to provide a new and improved mobile phone case.

It is a further object of the present invention to provide a new and improved mobile phone case with a convenient card slot.

It is a further object of the present invention to provide a new and improved mobile phone case that allows full use of the mobile phone while protecting the phone from external damage.

It is a further object of the present invention to provide a new and improved mobile phone case that includes a convenient, secure, and easy to use card slot.

### SUMMARY OF THE INVENTION

Briefly, to achieve the desired objects and aspects of the instant invention in accordance with a preferred embodiment thereof, provided is a mobile phone case including a body defining a cavity with dimensions substantially equal to a mobile phone. The cavity includes a bottom wall forming a rear wall of the body and side walls that enclose a mobile phone on the back and four edges. The body is formed of a flexible, resilient material. The rear wall of the body includes two parallel adjacent surfaces positioned to define a card pocket on the rear wall of the body. The card pocket is formed to receive therein one or more cards side-ways and parallel to the rear wall with a portion of the one or more cards exposed.

Desired objects and aspects of the instant invention are further achieved in accordance with a preferred embodiment thereof, in which a mobile phone case includes a body defining a cavity with length, width and depth dimensions substantially equal to the length, width and depth of a mobile phone. The body includes a rear wall forming a bottom wall of the cavity and the cavity includes side walls, the bottom wall and the side walls formed to enclose a mobile phone on the back and four edges. The body is formed of silicon rubber. The rear wall of the body includes two parallel adjacent surfaces positioned to define a card pocket on the rear wall of the body. The two parallel adjacent surfaces define the card pocket on the rear wall of the body including a first surface formed as a continuation of the bottom of the cavity and a second offset surface formed as an additional piece. The second offset surface lying in a plane parallel with and adjacent to the first surface and offset rearwardly from the first surface. The card pocket is formed to receive therein a card side-ways and parallel to the rear wall with a corner and two adjacent edges of the card exposed. The two parallel adjacent surfaces frictionally engage the card to hold the card securely in the card pocket, wherein the opening and the two parallel adjacent surfaces cooperate to frictionally engage the card sufficiently to securely hold the card in the card pocket while allowing convenient withdrawal of the card.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a front view of a mobile phone case in accordance with the present invention;

FIG. 2 is a rear view of the mobile phone case of FIG. 1;

FIG. 3 is a side view of the mobile phone case of FIG. 1, as seen from the bottom or lower side of FIG. 2;

FIG. 4 is a side view of the mobile phone case of FIG. 1, as seen from the top or upper side of FIG. 2;

FIG. 5 is an end view of the mobile phone case of FIG. 1, as seen from the left hand side of FIG. 2;

FIG. 6 is a front perspective view of the mobile phone case of FIG. 1, illustrating in more detail the phone receiving opening; and

FIG. 7 is a rear perspective view of the mobile phone case of FIG. 1, illustrating in more detail the card slot with card enclosed.

### DETAILED DESCRIPTION OF THE DRAWINGS

Turning now to the drawings in which like reference characters indicate corresponding elements throughout the several views, a mobile phone case 10 in accordance with the present invention is illustrated. In this preferred embodiment, case 10 is formed of a resilient, flexible material, such as silicon rubber. While other resilient flexible material might be used, silicon rubber is preferred for reasons that will be explained in more detail below.

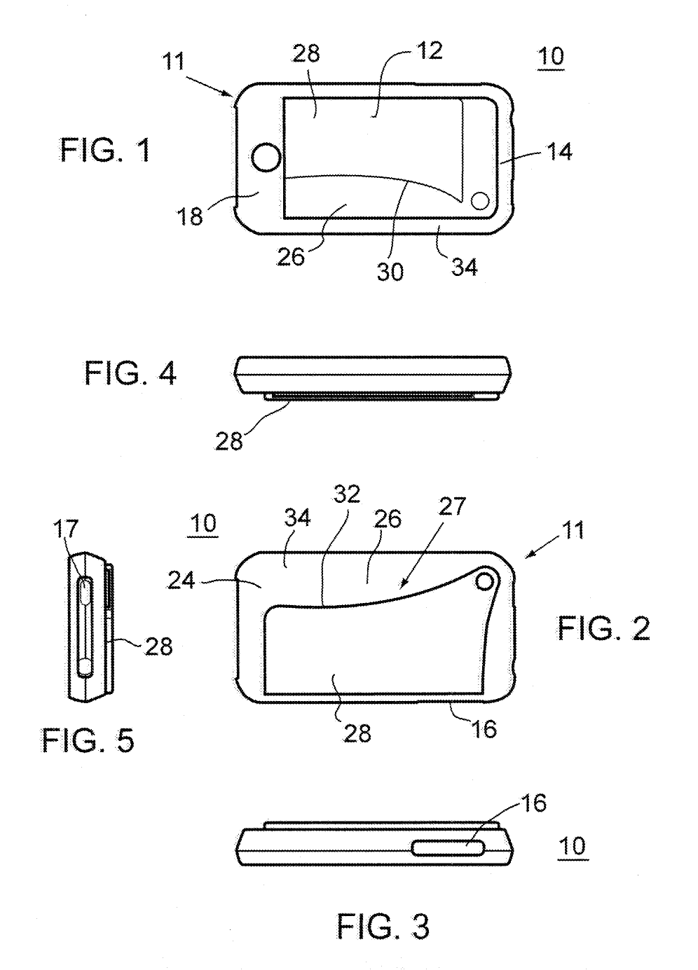

Attention is first directed to FIGS. 1 and 6 which illustrate a front view of case 10. As can be seen from these drawings, case 10 includes a body 11 that defines a phone receiving cavity 12, with dimensions substantially equal to a mobile phone, which covers a mobile phone received therein on the back and all four edges. The length, width, and depth of cavity 12 are sufficiently close to the same dimensions of a mobile phone enclosed therein that the phone will not move around but also will not cause undue stress (e.g. stretching, etc.) in body 11. Body 11 further includes a lip 14 extending completely around the edge or periphery of cavity 12 so that corners and exposed surfaces of an enclosed phone are covered and protected by the case. A mobile phone (not shown), such as an I-phone or Blackberry, is easily inserted into cavity 12 so that lip 14 extends slightly over the outer edges and firmly and securely holds the phone. Body 11 is designed to enclose and surround an entire mobile phone in cavity 12, except the front display. Since body 11 of case 10 is formed of flexible material, it is easily deformed to receive the phone and to resume the original shape around the phone. Also, because body 11 of case 10 is formed of resilient material any bumps or strikes, e.g. dropping or swinging the phone against an object, are absorbed rather than transferred to the phone.

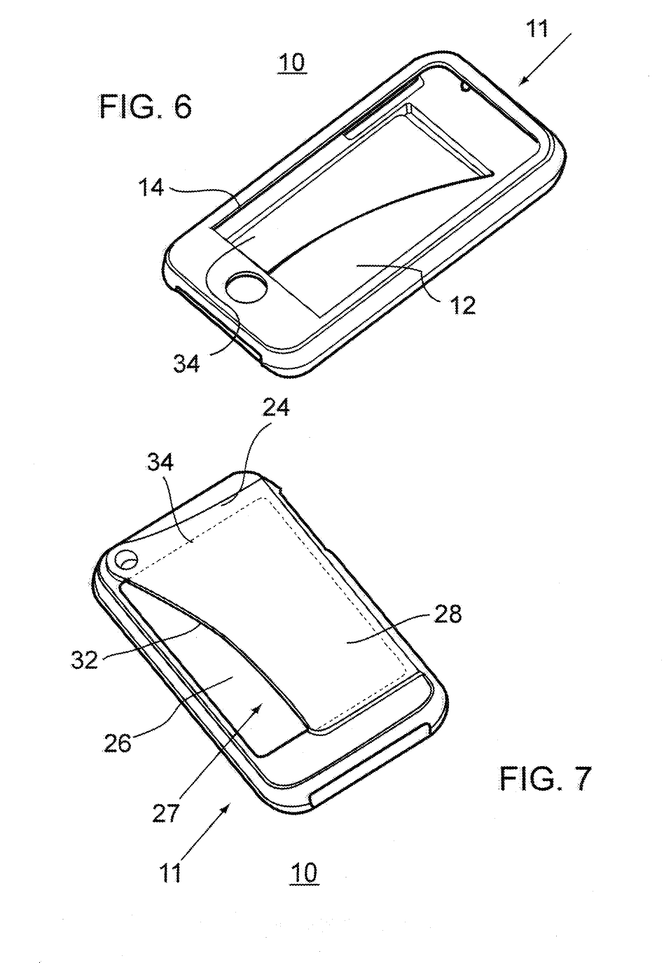

Phone receiving cavity 12 is formed to allow the entire display of an enclosed phone to be observed and interacted with by the user. Material of body 11 of case 10 extends outwardly the thickness of body 11 or the thickness of lip 14 from the front plane of the surface of the display so that even the surface of the display is somewhat protected from objects that might be positioned on it or that might otherwise come in contact with it. As can be seen in FIGS. 1 and 6, the left or lower lip, designated 18 and formed as a continuation of lip 14, is wider (horizontally) than the other three sides of lip 14 and includes a small circular opening 20 that is provided for control of an enclosed mobile phone. For example, opening 20 might expose an ON/OFF switch for the enclosed phone. Also, body 11 of case 10 is constructed with one or more accessory openings, such as opening 16 (see FIG. 3) or opening 17 (see FIG. 5), to allow external communication, e.g. plug-in devices or cords, with a phone contained in case 10.

Turning now to FIGS. 2 and 7, a rear view of case 10 is provided. As will be understood the rear wall, designated 24, forms at least partially the bottom wall of cavity 12. While the rear wall 24 of body 11 could optionally be a continuous wall that completely forms the bottom wall for cavity 12, in this preferred embodiment rear wall 24 is formed with two offset surfaces, designated 26 and 28, which cooperate to form a card pocket or slot 27. Surface 26 is formed as a continuation of what would normally be the bottom of cavity 12 and defines in this specific embodiment one edge 30 of an opening through the bottom of cavity 12 (see FIG. 1). The second or offset surface 28 of rear wall 24 is formed as an additional piece of material positioned to be in a plane parallel with surface 26 and offset rearwardly approximately the thickness of surface 26 (in this embodiment the thickness of body 11). Thus, surfaces 26 and 28 are in parallel adjacent planes. Further, offset surface 28 overlaps surface 26 along edge 30 sufficiently to close the opening through the bottom of cavity 12.

Surface 26 and offset surface 28 are formed to define credit/debit card pocket 27 designed to receive and secure one or more credit/debit cards (hereinafter simply “card” or “cards”) between surfaces 26 and 28. For convenience of understanding a typical card is represented by a solid line 34 in the figures even though portions of a card positioned in or carried by case 10 would not be visible (hereinafter card 34). At least the upper edge, designated 32, of offset surface 28 is curved or shaped to expose at least a portion (preferably a corner) of a card positioned between surface 26 and surface 28, as illustrated in FIGS. 2 and 7. Also, card pocket 27 is designed and formed to receive card 34 side-ways or perpendicular to a long edge thereof. At least the side edges of the opening through the bottom of cavity 12 form lips that overlie end edges of card 34 and separate card 34 from a mobile phone enclosed in cavity 12. In this specific embodiment surfaces 26 and 28 are formed to conveniently hold two cards but can be formed to specifically hold anywhere from one to several cards.

As explained briefly above, case 10 is formed of a resilient flexible material, preferably silicon rubber between 40 and 60 degrees of stiffness or hardness. Generally, the 60 degree silicon rubber is preferred because it is harder and provides extra protection. By forming case 10 of silicon rubber and by positioning surfaces 26 and 28 adjacent and parallel cards are securely held in case 10 by frictional engagement and cannot accidentally fall out. As explained above, rear wall 26 can form a continuous bottom wall of cavity 12 without an opening but it has been found that the two adjacent layers of silicon rubber are then so frictionally engaged with the surfaces of a card held therebetween that it is difficult to remove a card. Thus, in this preferred embodiment the opening is formed in the bottom wall of cavity 12 to aid in releasing one or more cards when it is desired to remove them. Also, by forming the card pocket so that cards are inserted side-ways sufficient pressure and friction are applied to securely hold the cards while allowing easy removal. This preferred embodiment is designed specifically to hold one or two cards since each card will be at least partially in contact with a surface of silicon rubber and will be frictionally engaged in the card pocket. If additional cards are included they will only be held by the pressure of the surfaces of adjacent cards.

Thus, a new and improved mobile phone case has been disclosed that allows full use of the mobile phone while protecting the phone from external damage. The new and improved mobile phone case is preferably formed of silicon rubber which absorbs any shocks or impacts that might otherwise damage a mobile phone enclosed therein. Also, the new and improved mobile phone case includes a convenient card slot or pocket that is designed to secure credit/debit cards while providing easy and convenient use of the cards. Because of the material and shape of the slot or pocket, cards are securely held in place while still allowing easy removal for use.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. A mobile phone case comprising:
a body defining a cavity with dimensions substantially equal to a mobile phone, the cavity including a bottom wall forming a rear wall of the body and side walls that enclose a mobile phone on the back and four edges, and the body being formed of a flexible, resilient material; and
the rear wall of the body including two parallel adjacent surfaces positioned to define a card pocket on the rear wall of the body, the card pocket being formed to receive therein one or more cards side-ways and parallel to the rear wall with a portion of the one or more cards exposed.

2. A mobile phone case as claimed in claim 1 wherein the flexible, resilient material includes silicon rubber.

3. A mobile phone case as claimed in claim 2 wherein the silicon rubber has a 40 to 60 degree stiffness or hardness.

4. A mobile phone case as claimed in claim 1 wherein the cavity has a generally rectangularly shaped opening substantially equal to a display on a mobile phone to be enclosed therein.

5. A mobile phone case as claimed in claim 4 wherein the cavity has a lip extending around four sides of the opening so as to be positioned in overlying relationship to a front face of a mobile phone enclosed within the cavity.

6. A mobile phone case as claimed in claim 1 wherein the two parallel adjacent surfaces defining the card pocket on the rear wall of the body include a first surface formed as a continuation of the bottom of the cavity and a second offset surface formed as an additional piece.

7. A mobile phone case as claimed in claim 6 wherein the second offset surface lies in a plane parallel with and adjacent to the first surface and offset rearwardly from the first surface.

8. A mobile phone case as claimed in claim 7 wherein the first surface includes an opening defined therein and the second offset surface substantially covers the opening.

9. A mobile phone case as claimed in claim 1 wherein the card pocket formed to receive the one or more cards side-ways and parallel to the rear wall is further formed to expose a corner and a portion of two adjacent edges of the one or more cards.

10. A mobile phone case comprising:
a body defining a cavity with length, width and depth dimensions substantially equal to the length, width and depth of a mobile phone, the body including a rear wall forming a bottom wall of the cavity, the cavity including side walls, the bottom wall and the side walls formed to enclose a mobile phone on the back and four edges;
the body being formed of silicon rubber; and
the rear wall of the body including two parallel adjacent surfaces positioned to define a card pocket on the rear wall of the body, the card pocket being formed to receive therein at least one card side-ways and parallel to the rear wall with a corner and two adjacent edges of the one card exposed, wherein the two parallel adjacent surfaces frictionally engage the at least one card to hold the at least one card securely in the card pocket.

11. A mobile phone case as claimed in claim 10 wherein the two parallel adjacent surfaces defining the card pocket on the rear wall of the body include a first surface formed as a continuation of the bottom of the cavity and a second offset surface formed as an additional piece.

12. A mobile phone case as claimed in claim 11 wherein the second offset surface lies in a plane parallel with and adjacent to the first surface and offset rearwardly from the first surface.

13. A mobile phone case as claimed in claim 12 wherein the first surface includes an opening defined therein and the second offset surface substantially covers the opening.

14. A mobile phone case as claimed in claim 10 wherein the opening and the two parallel adjacent surfaces cooperate to frictionally engage the at least one card sufficiently to securely hold the at least one card in the card pocket while allowing convenient withdrawl of the at least one card.

15. A mobile phone case comprising:
a body defining a cavity with length, width and depth dimensions substantially equal to the length, width and depth of a mobile phone, the body including a rear wall forming a bottom wall of the cavity, the cavity including side walls, the bottom wall and the side walls formed to enclose a mobile phone on the back and four edges;
the body being formed of silicon rubber;
the rear wall of the body including two parallel adjacent surfaces positioned to define a card pocket on the rear wall of the body, the two parallel adjacent surfaces defining the card pocket on the rear wall of the body including a first surface formed as a continuation of the bottom of the cavity and a second offset surface formed as an additional piece, the second offset surface lying in a plane parallel with and adjacent to the first surface and offset rearwardly from the first surface; and
the card pocket being formed to receive therein a card side-ways and parallel to the rear wall with a corner and two adjacent edges of the card exposed, the two parallel adjacent surfaces frictionally engage the card to hold the card securely in the card pocket, wherein the opening and the two parallel adjacent surfaces cooperate to frictionally engage the card sufficiently to securely hold the card in the card pocket while allowing convenient withdrawl of the card.

16. A mobile phone case as claimed in claim 15 wherein the silicon rubber has a 40 to 60 degree stiffness or hardness.

17. A mobile phone case as claimed in claim 15 wherein the cavity has a generally rectangularly shaped opening substantially equal to a display on a mobile phone to be enclosed therein.

18. A mobile phone case as claimed in claim 17 wherein the cavity has a lip extending around four sides of the opening so as to be positioned in overlying relationship to a front face of a mobile phone enclosed within the cavity.
